(19) United States
(12) Patent Application Publication
(10) Pub. No.: US 2019/0243357 A1
(43) Pub. Date: Aug. 8, 2019

(54) WEARABLE UAV CONTROL DEVICE AND UAV SYSTEM

(71) Applicant: SZ DJI TECHNOLOGY CO., LTD., Shenzhen (CN)

(72) Inventors: Hualiang Qiu, Shenzhen (CN); Zhongqian You, Shenzhen (CN); Jinji Li, Shenzhen (CN); Youcheng Zhao, Shenzhen (CN); Xiaofeng Feng, Shenzhen (CN); Jian Feng, Shenzhen (CN)

(21) Appl. No.: 16/388,168

(22) Filed: Apr. 18, 2019

Related U.S. Application Data
(63) Continuation of application No. PCT/CN2016/102615, filed on Oct. 19, 2016.

(51) Int. Cl. G05D 1/00; G05D 1/10; B64C 39/02; G05D 1/12; B64D 47/08; H04N 5/232

(52) U.S. Cl. CPC G05D 1/0038; G05D 1/0016; G05D 1/0022; G05D 1/0094; G05D 1/101; B64C 39/024; G09G 3/3406; B64D 47/08; H04N 5/23206; B64C 2201/127; B64C 2201/146; B64C 2201/08; B64C 2201/18; G05D 1/12

(57) ABSTRACT

A wearable device for controlling an unmanned aerial vehicle (UAV) includes one or more sensors configured to detect first status information of the wearable device, a communication circuit configured to transmit the first status information to the UAV and receive second status information of the UAV from the UAV, and a processor configured to generate a control instruction according to at least one of the first status information or the second status information, and control the communication circuit to transmit the control instruction to the UAV to control the UAV.

### CROSS-REFERENCES TO RELATED APPLICATION

This application is a continuation of International Application No. PCT/CN2016/102615, filed on Oct. 19, 2016, the entire contents of which are hereby incorporated by reference.

### TECHNICAL FIELD

The present disclosure generally relates to the field of unmanned aerial vehicle and, more particularly, relates to a wearable unmanned-aerial-vehicle control device, and a system thereof.

### BACKGROUND

Unmanned aerial vehicle (UAV), as a new flying device, has been widely applied in a variety of fields such as entertainment, agriculture, geology, meteorology, power supply, emergency rescue, disaster relief, etc. At present, the remote control of UAV is mainly realized through a hand-held remote-control device for wireless communication with UAV, which has many disadvantages such as large size, inconvenience in carrying, etc. In the meantime, the adjustment of the UAV's flight status and the angle captured from the imaging device mounted on the UAV remains dependent on visually remote control by an operator. This requires considerable experience from the operator and high proficiency in operation of the hand-held remote-control terminal.

### BRIEF SUMMARY OF THE DISCLOSURE

In accordance with the disclosure, there is provided a wearable device for controlling an unmanned aerial vehicle (UAV). The wearable device includes one or more sensors configured to detect first status information of the wearable device, a communication circuit configured to transmit the first status information to the UAV and receive second status information of the UAV from the UAV, and a processor configured to generate a control instruction according to at least one of the first status information or the second status information, and control the communication circuit to transmit the control instruction to the UAV to control the UAV.

### BRIEF DESCRIPTION OF THE DRAWINGS

FIG. 1 illustrates a schematic diagram of an exemplary unmanned aerial vehicle system consistent with disclosed embodiments.

FIG. 2 illustrates a schematic block diagram of an exemplary wearable device consistent with disclosed embodiments.

FIG. 3 illustrates a schematic block diagram of an exemplary unmanned aerial vehicle consistent with disclosed embodiments.

FIG. 4 illustrates a schematic diagram showing control of an exemplary unmanned aerial vehicle in accordance with the status information of an exemplary wearable device consistent with disclosed embodiments.

FIG. 5 illustrates another schematic diagram showing control of an exemplary unmanned aerial vehicle in accordance with the status information of an exemplary wearable device consistent with disclosed embodiments.

FIG. 6 illustrates another schematic diagram showing control of an exemplary unmanned aerial vehicle in accordance with the status information of an exemplary wearable device consistent with disclosed embodiments.

FIG. 7 illustrates a schematic diagram showing association of a motion path with images and videos consistent with disclosed embodiments; and

FIG. 8 illustrates a schematic external view of an exemplary wearable device consistent with disclosed embodiments.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. Wherever possible, the same reference numbers will be used throughout the drawings to refer to the same or like parts. The described embodiments are some but not all of the embodiments of the present disclosure. Based on the disclosed embodiments, persons of ordinary skill in the art may derive other embodiments consistent with the present disclosure, all of which are within the scope of the present disclosure. Further, in the present disclosure, the disclosed embodiments and the features of the disclosed embodiments may be combined under conditions without conflicts.

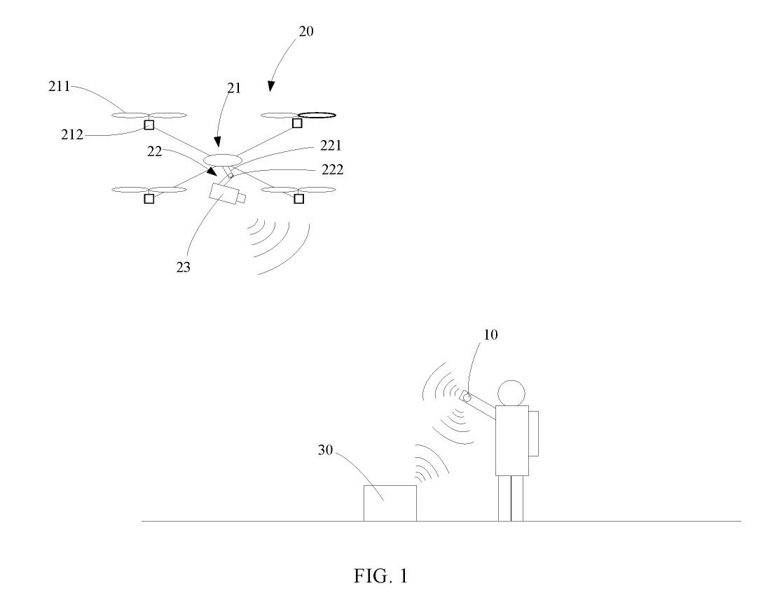

FIG. 1 illustrates a schematic diagram of an exemplary unmanned aerial vehicle (UAV) system consistent with disclosed embodiments. The UAV system consistent with the present disclosure includes a wearable device 10 and a UAV 20. The UAV 20 includes a flying body 21, a gimbal 22 and an imaging device 23. In some embodiments, the flying body 21 includes a plurality of rotor blades 211, and a rotor motor 212 that drives the plurality of rotor blades 211 to rotate, thereby supplying the power required for the UAV 20 to fly. The imaging device 23, through the gimbal 22, may be mounted on the flying body 21. The imaging device 23 may capture pictures or videos during flight of the UAV 20. The imaging device 23 may include but not limited to a multispectral imager, a hyperspectral imager, a visible-light camera, an infrared camera, etc. The gimbal 22 may serve as a multi-axis transmission and a stabilization system, and includes a plurality of rotation shafts 221 and a gimbal motor 222. The gimbal motor 222, by adjusting the rotation angle of the plurality of rotation shafts 221, may compensate for the shooting angle of the imaging device 23, and may be configured with an appropriate buffer member to prevent or reduce vibration of the imaging device 23. In some other embodiments, the imaging device 23 may be directly or by other means mounted on the flying body 21. The wearable device 10, worn by the operator, may communicate with the UAV 20 through wireless communication, thus controlling the flight of the UAV 20 and the shooting of the imaging device 23.

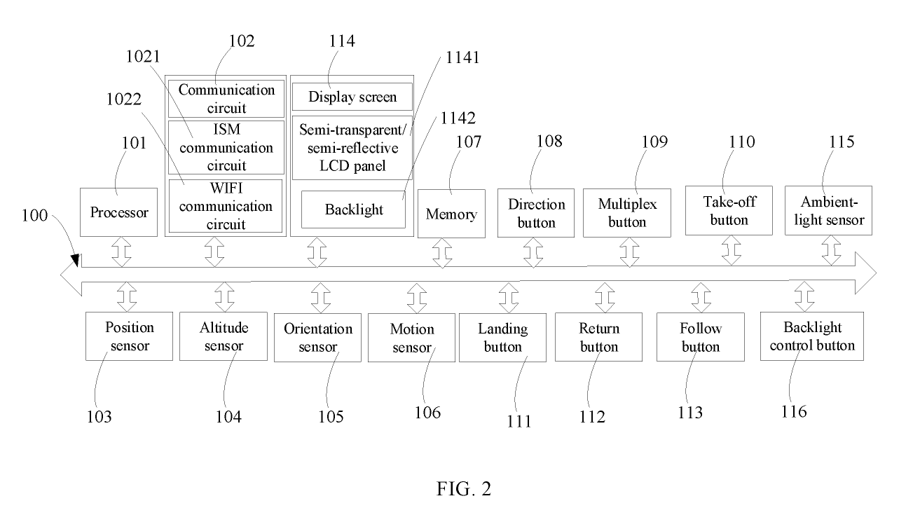

FIG. 2 illustrates a schematic block diagram of an exemplary wearable device consistent with disclosed embodiments. The wearable device 10 consistent with the present disclosure includes a processor 101, a communication circuit 102, and at least one sensor. The at least one sensor in the wearable device 10 may detect the status information of the wearable device 10. Further, the wearable device 10 or the UAV 20, at least according to the status information of the wearable device 10, may generate a corresponding control instruction. The control instruction may include but is not limited to a flight control instruction or a shooting control instruction, in which the flight control instruction may control the flight status (e.g., position, altitude, direction, speed, and gesture, etc.) of the UAV 20, and the shooting control instruction may control the shooting status (e.g., shooting direction, shooting time, exposure parameter, etc.) of the imaging device 23 mounted on the UAV 20.

For example, in some embodiments, the processor 101 of the wearable device 10, through the communication circuit 102, may transmit the status information of the wearable device 10 to the UAV 20. According to the status information of the wearable device 10 and the status information of the UAV 20 itself, the UAV 20 may generate the corresponding control instruction. In another embodiment, according to the status information of the wearable device 10, or according to the status information of the wearable device 10 and the status information of the UAV 20 received by the communication circuit 102 from the UAV 20, the processor 101 of the wearable device 10 may generate the control instruction, and via the communication circuit 102 may transmit the control instruction to the UAV 20.

Through the above-mentioned method, a ground-control terminal of the UAV may be set as a form of the wearable device, which can effectively improve the portability of the ground-control terminal. Further, according to the detected status information of the wearable device, the corresponding control instruction may be generated, thus effectively reducing operaton complexity.

In some embodiments, the sensors in the wearable device 10 include a position sensor 103, an altitude sensor 104, an orientation sensor 105, and a motion sensor 106. The position sensor 103 may detect the position information of the wearable device 10, which, in some embodiments, may include a GPS-satellite-position sensor or a Beidou-satellite-position sensor, and may acquire latitude and longitude coordinates of the wearable device 10, thus achieving the two-dimensional positioning on the horizontal plane for the wearable device 10.

The altitude sensor 104 may detect the altitude information of the wearable device, which, in some embodiments, may include a barometer, an ultrasonic distance meter, or an infrared distance meter, etc. Taking the barometer as an example, by detecting the actual barometric pressure value of the position where the wearable device 10 is present, the barometer may obtain the altitude information of the wearable device. The processor 101, the built-in processor of the barometer, or other processors may calculate the relative altitude of the wearable device 10 relative to the reference position, according to the difference between the actual barometric pressure value detected and the reference barometric pressure value of the reference position. Further, when the UAV 20 is also provided with a barometer, the relative altitude between the UAV 20 and the wearable device 10 can be calculated through the difference in the barometric pressure values, measured by the barometer of the wearable device 10 and the barometer of the UAV 20.

The orientation sensor 105 may detect the orientation information of the wearable device 10, which, in some embodiments, may include a compass, etc. The orientation information of the wearable device 10 may be represented by an angle of a certain preset reference direction of the wearable device 10 relative to a standard direction (e.g., east, west, south, or north).

The motion sensor 106 may detect the motion parameter (e.g., direction, speed, acceleration, gesture, and/or motion path, etc.) of the wearable device 10, which, in some embodiments, may include an inertial sensor, or an image sensor, etc.

As understood by those skilled in the art, the above-mentioned position sensor 103, altitude sensor 104, orientation sensor 105 and motion sensor 106 are merely examples of the sensors that can be configured in the wearable device 10. In actual use, according to actual needs, one or more of the above-mentioned sensors may be selected to achieve a specific function. Further, the processor 101, the communication circuit 102, the above-mentioned sensors, and other functional modules may communicate with each other via a bus 100. In some other embodiments, the above-mentioned functional modules may communicate with each other in other manners.

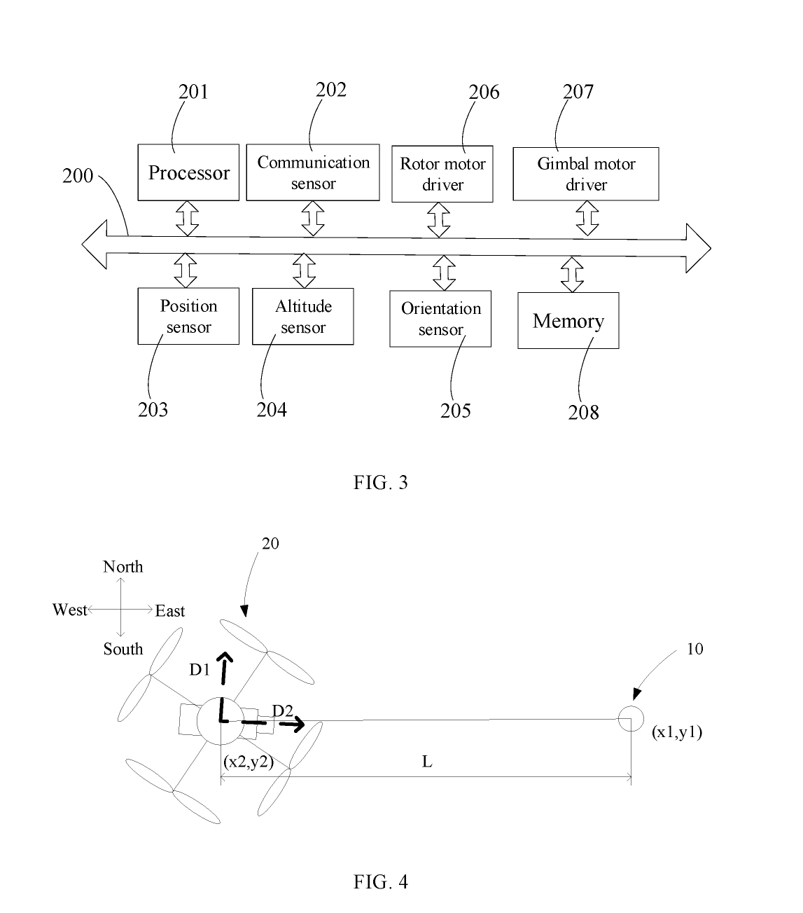

FIG. 3 illustrates a schematic block diagram of an example of the unmanned aerial vehicle 20 consistent with disclosed embodiments. The UAV 20 consistent with the present disclosure includes a processor 201, a communication circuit 202, and at least one sensor. The at least one sensor of the UAV 20 may detect the status information of the UAV 20 and, in some embodiments, include a position sensor 203, an altitude sensor 204, and an orientation sensor 205. The position sensor 203 may detect the position information of the UAV 20, the altitude sensor 204 may detect the altitude information of the UAV 20, and the orientation sensor 205 may detect the orientation information of the UAV 20. The specific implementation of the sensors has been set forth above, which is not repeated here. The communication circuit 202 may communicate with the communication circuit 102, thus realizing the data transmission between the wearable device 10 and the UAV 20.

In some embodiments, the control instruction may be generated by the UAV 20. In these embodiments, the processor 101 of the wearable device 10 may transmit the status information of the wearable device 10 to the UAV 20 via the communication circuit 102 and the communication circuit 202, and the processor of the UAV 20 may generate the corresponding control instruction according to the received status information of the wearable device 10, or according to the status information of the wearable device 10 and the status information of the UAV 20.

In some embodiments, the control instruction may be generated by the wearable device 10. In these embodiments, the processor 101 of the wearable device 10 may generate the control instruction directly according to the status information of the wearable device 10. Alternatively, the processor 201 of the UAV 20 may transmit the status information of the UAV 20 to the wearable device 10 via the communication circuit 202 and the communication circuit 102. The processor 101 of the wearable device 10 may then generate the control instruction according to the status information of the wearable device 10 and the status information of the UAV 20, and may further transmit the control instruction to the UAV 20 via the communication circuit 102 and the communication circuit 202.

As understood by those skilled in the art, the above-mentioned position sensor 203, altitude sensor 204, and orientation sensor 205 are merely examples of the sensors that can be arranged in the UAV 20. In the actual use, according to the actual needs, one or more of the above-mentioned sensors may be selected to achieve a specific function, or other sensors may be further added to achieve the corresponding functions. Further, the processor 201, the communication circuit 202, the above-mentioned sensors, and other functional modules may communicate via a bus 200. In some other embodiments, the above-mentioned modules may communicate with each other in other manners and may be distributedly arranged at any one or more of the flying body 21, the gimbal 22, and the imaging device 23.

The following embodiments will illustrate specific examples of how to utilize the status information of the wearable device 10, or the status information of the wearable device 10 and the status information of the UAV 20 to generate the control instruction.

FIG. 4 illustrates a schematic diagram of controlling an exemplary unmanned aerial vehicle (UAV) in accordance with the status information of an exemplary wearable device consistent with disclosed embodiments.

In some embodiments, when the processor 101 of the wearable device 10 or the processor 201 of the UAV 20 acquires the position information (x1, y1) of the wearable device 10 and the position information (x2, y2) of the UAV 20, the processor 101 or the processor 201 may generate the corresponding flight control instruction according to the above two pieces of position information. A projection distance L on the horizontal plane, between the UAV 20 and the wearable device 10, may be adjusted according to the flight control instruction.

For example, according to the above two pieces of position information, the distance on the horizontal plane between the projections of the UAV 20 and the wearable device 10, i.e., the projection distance L, can be calculated. In accordance with the comparison result of the calculated projection distance L and a preset distance range, the flight control instruction may be generated. Thus, through controlling the rotation speed of the rotor motor 212 by the rotor motor driver 206 of the UAV 20, the UAV 20 may be controlled to move forward or backward on the horizontal plane with respect to the wearable device 10, thus allowing the projection distance L on the horizontal plane, between the UAV 20 and the wearable device 10, to remain within the preset distance range. In this manner, tracking of the horizontal distance of the UAV 20 relative to the wearable device 10 can be achieved.

In some embodiments, when the processor 101 of the wearable device 10 or the processor 201 of the UAV 20 acquires the position information (x1, y1) of the wearable device 10 and the position information (x2, y2) and orientation information of the UAV 20, the processor 101 or the processor 201 may generate the flight control instruction or the shooting control instruction according to the above information. Thus, through the flight control instruction, a preset reference direction D1 of the UAV 20 on the horizontal plane may be adjusted. Alternatively, through the shooting control instruction, the shooting direction D2 of the imaging device 23 mounted on the UAV 20 on the horizontal plane may be adjusted.

For example, the angle of the preset reference direction D1 of the UAV 20 relative to the standard direction (e.g., east, south, west, or north) can be calculated via the orientation information of the UAV 20. Alternatively, according to the orientation information of the UAV 20 and the rotation angle of each shaft of the gimbal 22, the angle of the shooting direction D2 of the imaging device 23 relative to the standard direction (e.g., east, south, west, or north) can be calculated. Further, through the position information (x1, y1) and the position information (x2, y2), the angle of a straight line, connecting the projections of the UAV 20 and the wearable device 10 on the horizontal plane, relative to the standard direction can be calculated. Through the above-mentioned angles, the angle of the preset reference direction D1 or the shooting direction D2 relative to the above-mentioned connecting line can be calculated, the flight control instruction or the shooting control instruction may be generated. Further, the rotation speed of the rotor motor 212 or the rotation angle of the gimbal motor 222 may be controlled by the rotor motor driver 206 of the UAV 20 or the gimbal motor driver 207. Thus, the preset reference direction D1 or the shooting direction D2 may be adjusted to point to the wearable device 10. In this manner, the shooting and tracking by the UAV20 of the wearable device 10 in the horizontal dimension can be realized.

The adjustment methods described above can be applied simultaneously or separately, or can be combined with another tracking method, which is not limited herein. For example, any of the above-described adjustment methods can be combined with a visual tracking method to ensure the accuracy of visual tracking.

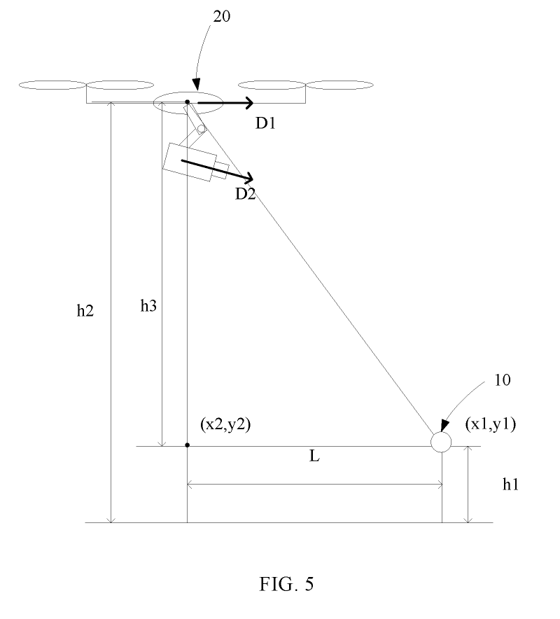

FIG. 5 illustrates another schematic diagram showing control of an exemplary unmanned aerial vehicle in accordance with the status information of an exemplary wearable device consistent with disclosed embodiments.

In some embodiments, when the processor 101 of the wearable device 10 or the processor 201 of the UAV 20 acquires the altitude information h1 of the wearable device 10 and the altitude information h2 of the UAV 20, the processor 101 or the processor 201 may generate the flight control instruction according to the altitude information h1 and the altitude information h2. Thus, the relative altitude h3 between the UAV 20 and the wearable device 10 may be adjusted according to the flight control instruction. As described above, in this embodiment, the altitude information h1 and the altitude information h2 may include barometric pressure values, or other detected values that can indicate the altitude. Also, the actual altitude may be acquired by conversion via the above other values or detected values.

For example, according to the above-mentioned two pieces of altitude information, the relative altitude h3 between the UAV 20 and the wearable device 10 can be calculated. In accordance with the comparison result of the calculated relative altitude h3 and a preset altitude range, the flight control instruction may be generated. Further, through controlling the rotation speed of the corresponding rotor motor 212 by the rotor motor driver 206 of the UAV 20, ascending or descending of the UAV 20 relative to the wearable device 10 may be controlled in the vertical dimension, such that the relative altitude between the UAV 20 and the wearable device 10 can remain within the preset altitude range. In this manner, tracking of the UAV 20 relative to the wearable device 10 can be achieved in the vertical dimension.

In some embodiments, when the processor 101 of the wearable device 10 or the processor 201 of the UAV 20 acquires the position information (x1, y1) and the altitude information (h1) of the wearable device 10, and the position information (x2, y2) and the altitude information (h2) of the UAV 20, the processor 101 or the processor 201 may generate the flight control instruction or the shooting control instruction may be generated according to the above information,. Thus, the preset reference direction D1 of the UAV 20 may be adjusted in the vertical dimension according to the flight control instruction, or the shooting direction D2 of the imaging device 23 mounted on the UAV 20 may be adjusted in the vertical dimension according to the shooting control instruction.

For example, through the position information (x1, y1) and the position information (x2, y2), the projection distance L between the wearable device 10 and the UAV 20 can be calculated. Also, through the altitude information (h1) and the altitude information (h2), the relative altitude (h3) between the wearable device 10 and the UAV 20 can be calculated. Further, according to the projection distance (L) and the relative altitude (h3), the angle of a straight line, connecting the UAV 20 and the wearable device 10, relative to the vertical direction can be calculated. Also, according to the angle, the flight control instruction or the shooting control instruction may be generated. Thus, the rotation speed of the rotor motor 212 or the rotation angle of the gimbal motor 222 may be controlled by the rotor motor driver 206 of the UAV 20 or the gimbal motor driver 207, such that the preset reference direction D1 or the shooting direction D2 may be adjusted to point to the wearable device 10. In this manner, the shooting and tracking by the UAV20 of the wearable device 10 in the vertical dimension can be realized.

The adjustment methods described above in connection with FIG. 5 may be further combined with the adjustment methods described above in connection with FIG. 4, such that three-dimensional distance tracking and shooting tracking can be achieved.

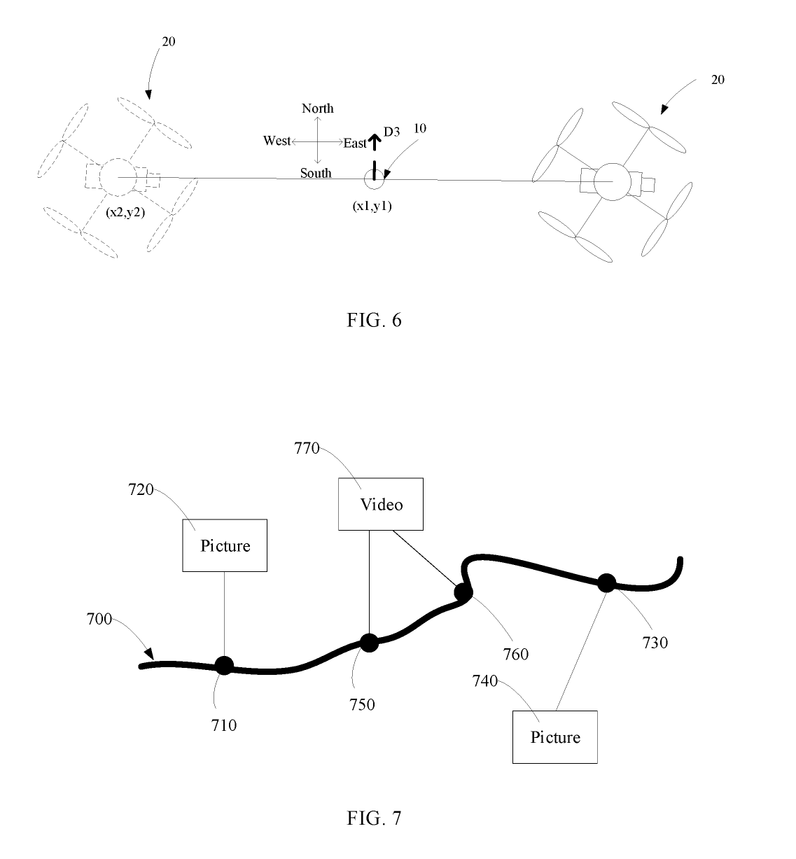

FIG. 6 illustrates another schematic diagram showing control of an exemplary unmanned aerial vehicle in accordance with the status information of an exemplary wearable device consistent with disclosed embodiments.

In some embodiments, when the processor 101 of the wearable device 10 or the processor 201 of the UAV 20 acquires the position information (x1, y1) of the wearable device 10, and the orientation information and the position information (x2, y2) of the UAV 20, the processor 101 or the processor 201 may generate the flight control instruction according to the above-mentioned information. Thus, the relative orientation of the UAV 20 and the wearable device 10 (e.g., front, back, left, and right relative to the preset reference direction of the wearable device 10) may be adjusted according to the flight control instruction.

For example, according to the orientation information of the wearable device 10, the angle between a preset reference direction D3 of the wearable device 10 and the standard direction (e.g., east, south, west, or north) can be determined. Further, through the position information (x1, y1) of the wearable device 10 and the position information (x2, y2) of the UAV 20, the angle between the straight line, connecting the projections of the wearable device 10 and the UAV 20 on the horizontal plane, and the standard direction can be calculated. Also, according to the above-mentioned angle, the angle between the above connecting line and the preset reference direction D3 of the wearable device 10 can be calculated. Further, according to actual needs, the to-be-adjusted angle of the UAV 20 around the wearable device 10 can be determined, and the flight control instruction may be generated in accordance with the to-be-adjusted angle. Also, through controlling the rotation speed of the rotor motor 212 by the rotor motor driver 206 of the UAV 20, the orientation of the UAV 20 around the wearable device 10 may be adjusted. For example, as shown in FIG. 6, the UAV 20 is controlled to fly from the left side to the right side of the wearable device 10. In some embodiments, as the wearable device 10 rotates by itself, the UAV 20 may be always kept within the preset orientation range with respect to the wearable device 10, for example, the UAV 20 always remains on the right side of the wearable device 10.

The adjustment method described in connection with FIG. 6 may be combined with the adjustment methods described in connection with FIG. 4 and FIG. 5, such that the UAV 20 can keep tracking distance and shooting while performing orientation adjustment.

FIG. 7 illustrates a schematic diagram showing association of a motion path with images and videos consistent with disclosed embodiments.

In some embodiments, the processor 101 of the wearable device 10 or the processor 201 of the UAV 20 may record the position information (x1, y1) of the wearable device 10 or the position information (x2, y2) of the UAV 20, acquired, for example, in accordance with the above embodiments. Thus, the motion path 700 of the wearable device 10 or the UAV 20 may be generated. Further, the pictures or videos captured by the UAV 20 may be associated with the motion path 700.

For example, the processor 201 of the UAV 20 may further record the position information (x2, y2) of the UAV 20 while recording the pictures or videos. When the UAV 20 captures the pictures or videos, the processor 101 of the wearable device 10 or the processor 201 of the UAV 20 may further match the position information (x2, y2) to the position information (x1, y1) or (x2, y2) on the motion path, and may correlate the pictures or videos with position points on the motion path 700 that match the position information (x2, y2) when capturing the pictures or videos. For example, as shown in FIG. 7, a picture 720 is associated with a position point 710, a picture 740 is associated with a position point 730, and a video 770 is associated with position points 750 and 760, where the position points 750 and 760 correspond to the starting position and the ending position of capturing the video 770, respectively.

In some embodiments, the pictures or videos associated with the motion path 700 may be saved as thumbnail images. The specific association may be saved in the form of an image shown in FIG. 7, or may be saved in another manner, such as a table. In some embodiments, the thumbnail image of a picture or a video may be also set with a hyperlink. Thus, by clicking the hyperlink, the actual storage location, to which the picture or video is pointed, may be obtained to acquire the clearer and complete picture or video.

Moreover, the processor 201 of the UAV 20 may further record other status information of the UAV 20 upon capturing the pictures or videos, such as the altitude information or the orientation information, etc., which may be presented on the motion path 700, the pictures, or the videos. For example, through disposing the pictures 720 and 740 on the two sides of the motion path 700, respectively, it may be indicated that when capturing the pictures 720 and 740, the orientations of the UAV 20 relative to the wearable device 10 are different (e.g., upon capturing the picture 720, the UAV 20 may be present on the right side of the wearable device 10, while upon capturing the picture 740, the UAV 20 may be present on the left side of the wearable device 10).

Further, as shown in FIG. 2, the wearable device 10 also includes motion sensor 106, detecting motion parameters of the wearable device 10. The processor 101 of the wearable device 10 or the processor 201 of the UAV 20 may generate the control instruction, in accordance with the motion parameters of the wearable device 10.

Generating the control instruction according to the motion parameters of the wearable device 10 may include the following two methods.

In one method, a memory 107 is arranged at the wearable device 10, or a memory 208 is arranged at the UAV 20. The memory 107 or the memory 208 may store at least one action template and at least one candidate control instruction associated with the at least one action template. The processor 101 of the wearable device 10 or the processor 201 of the UAV 20 may match the action template to the control instruction, formed according to the above-mentioned motion parameters, and may generate the control instruction associated with the matched action template. In some embodiments, the motion parameters detected by the motion sensor 106 may include, but are not limited to, direction, speed, acceleration, gesture, and/or motion path, etc. For example, the motion sensor 106 may include an inertial sensor. The motion parameters outputted by the inertial sensor may be directly used as action instruction, or the motion parameters may be calculated to form the action instruction (e.g., by integrating over time). Hence, an action template may be set as the direction, speed or acceleration of the wearable device 10 to satisfy a preset change rule, or an action template may be set to satisfy a specific gesture or a specific motion path. At this time, the processor 101 or the processor 201 may match the direction, speed or acceleration, detected by the motion sensor 106, to the above-mentioned change rule of the action template, or may match the gesture, motion path, etc., obtained by integrating speed, acceleration over time, to the above-mentioned gesture or motion path. Since the amount of the data required to calculate and match the motion parameters is relatively large, after the above steps have been performed by the processor 101 of the wearable device 10, the control instruction may be transmitted to the UAV 20.

In some embodiments, the processor 101 of the wearable device 10 or the processor 201 of the UAV 20 may generate a call control instruction according to the motion parameters. For example, the motion path matching a hand-waving gesture of the operator wearing the wearable device 10, or the change rule of the direction, speed, or acceleration may be set as the action template, and may be associated with the call control instruction. Thus, according to the motion parameters detected by the motion sensor 106, along with the above-mentioned action template, whether the motion of the operator wearing the wearable device 10 is the hand-waving gesture may be detected. If the motion is the hand-waving gesture, the call control gesture may be generated. At this point, the processor 101 or the processor 201 may further respond to the call control instruction to generate the flight control instruction or the shooting control instruction, in which the flight control instruction may control the flight status of the UAV 20, and the shooting control instruction may control the shooting status of the imaging device 23 mounted on the UAV 20. For example, according to the flight control instruction or the shooting control instruction, the processor 201 may further adjust the relative position of the UAV 20 and the wearable device 10 or the shooting direction of the imaging device 23, thus achieving the capturing towards the operator wearing the wearable device 10, and in turn acquiring the pictures or videos containing the above operator.

Further, the processor 101 or the processor 201 may visually recognize the operator from the captured pictures or videos, for example, may visually recognize the hand-waving gesture or the face of the operator, which can help the operator with subsequent operations. For example, by visually recognizing the operator's subsequent actions, the subsequent motions of the UAV 20 may be controlled.

In another method, the processor 101 of the wearable device 10 or the processor 201 of the UAV 20 may directly map the above motion parameters into the flight control instruction or the shooting control instruction. The flight control instruction may control the flight status of the UAV 20, while the shooting control instruction may control the shooting status of the imaging device 23 mounted on the UAV 20, thus synchronously adjusting the flight status or the shooting status during the movement of the wearable device 10.

For example, the processor 101 of the wearable device 10 or the processor 201 of the UAV 20 may directly map the motion parameters, such as direction, speed, acceleration, gesture, etc., into the flight control instructions of the flight status that can control the direction, speed, acceleration, gesture, etc. of the UAV 20, thus allowing the UAV 20 to synchronously move with the wearable device 10 according to the identical motion path or gesture.

As understood by those skill in the art, the above-mentioned position sensor 103, altitude sensor 104, orientation sensor 105 and motion sensor 106 are merely examples of sensors that may be configured on the wearable device 10. In the actual use, according to the actual need, one or more of the above sensors may be selected to achieve a specific function, or other sensors may be further added to achieve corresponding functions. For example, an inclination angle of the wearable device 10 may be detected by a gravity sensor. And the flight control instruction or the shooting control instruction may be generated to control a flight direction of the UAV or the shooting direction of the imaging device 23. Further, the information of distance and orientation relative to a target object may be detected by a distance sensor and an orientation sensor. Using the target object instead of the wearable device 10 and combining the various tracking methods described above may control the UAV 20 to track the target object.

Further, as shown in FIG. 2, the wearable device 10 includes at least one button. The processor 101 of the wearable device 10 may generate the control instruction according to a user's operation of the at least one button. For example, the at least one button on the wearable device 10 includes a direction button 108 for generating the flight control instruction or the shooting control instruction. As described above, the flight control instruction may control the flight status of the UAV 20, and the shooting control instruction may control the shooting status of the imaging device 23 mounted on the UAV 20. Further, the wearable device 10 may be configured with a multiplex button 109. When the multiplex button 109 is present in a first state, the direction button 108 may generate the flight control instruction. When the multiplex button 109 is present in a second state, the direction button 108 may generate the shooting control instruction.

Further, the wearable device 10 may be configured with a take-off button 110, a landing button 111, a return button 112, and a follow button 113. The take-off button 110 may control the UAV 20 to take off. The landing button 111 may control the UAV 20 to land. The return button 112 may control the UAV 20 to return to a preset position, for example, return to a current position where the wearable device 10 is present or another position specified by the user. The follow button 113 may control the UAV 20 to follow a preset target to fly, for example, after the operator presses the follow button 113, the UAV 20 may automatically take off, and follow the wearable device 10 to fly, according to one or more of the methods described above, such as the distance tracking, the capturing tracking, and the orientation tracking.

As understood by those skilled in the art, the above-mentioned buttons are merely exemplary. In the actual use, one or more of the foregoing buttons may be selected to achieve a specific function according to the actual needs, or other buttons may be further added to achieve the corresponding functions. Moreover, the foregoing buttons may be implemented by physical buttons or virtual buttons, which are not limited herein.

Further, the wearable device includes a display screen 114. The display screen 114 may display the status information of the wearable device 10, and one or more of the status information, pictures, and videos of the UAV 20 transmitted back by the communication circuits 102 and 202.

In some embodiments, the display screen 114 includes a semi-transparent/semi-reflective liquid crystal display (LCD) panel 1141 and a backlight module 1142. The wearable device 10 further includes a backlight control button 115 or an ambient-light sensor 116. The backlight module 1142 may selectively provide a backlight for the semi-transparent/semi-reflective LCD panel 1141, according to a backlight control instruction generated by the backlight control button 115, or according to an ambient-light intensity detected by the ambient-light sensor 116. For example, when ambient-light brightness is relatively high or the backlight control button 115 is in a first state, the backlight module 1142 may not provide backlight, and the semi-transparent/semi-reflective LCD panel 1141 may only rely on the ambient light for display. When the ambient-light brightness is relatively low or the backlight button 115 is in a second state, the backlight module 1142 may provide backlight, and the semi-transparent/semi-reflective LCD panel 1141 may mainly rely on the backlight for display. Since the backlight is not always on, power consumption can be saved. The specific control of the backlight module 1142 may be implemented by the processor 101, a built-in processor of the display screen 114, or another processor, which is not limited here.

The UAV system consistent with the present disclosure may further include a server terminal (not shown). In some embodiments, as shown in FIG. 2, the communication circuit of the wearable device 10 includes an ISM (Industrial Scientific Medical band) communication circuit 1021 and a WIFI communication circuit 1022. The ISM communication circuit 1021 may communicate with the UAV 20. The WIFI communication circuit 1022 may communicate with the server terminal, to download data from the server terminal or upload data to the server terminal. For example, the status information of the wearable device 10, or the status information, pictures, or videos received from the UAV 20 may be uploaded to the server terminal, and installation or upgrading files required by the wearable device 10 may be downloaded from the server terminal.

In addition, the UAV 20 and the server terminal 30 may also communicate with each other through a WIFI communication circuit, such that the status information, pictures or videos received by the UAV 20 may be directly uploaded to the server terminal. Further, in some embodiments, the status information or the control instruction may be only transmitted between the wearable device 10 and the UAV 20, while other data may be transmitted between the UAV 20 and the server terminal, and between the wearable device 10 and the server terminal. For example, the status information of the wearable device 10 or an uplink control instruction may be only transmitted between the wearable device 10 and the UAV 20. The status information of the UAV 20 and the pictures or videos captured by the UAV 20 may be transmitted between the UAV 20 and the server terminal, and afterwards may be downloaded by the wearable device 10 from the server terminal according to the own needs of the wearable device 10.

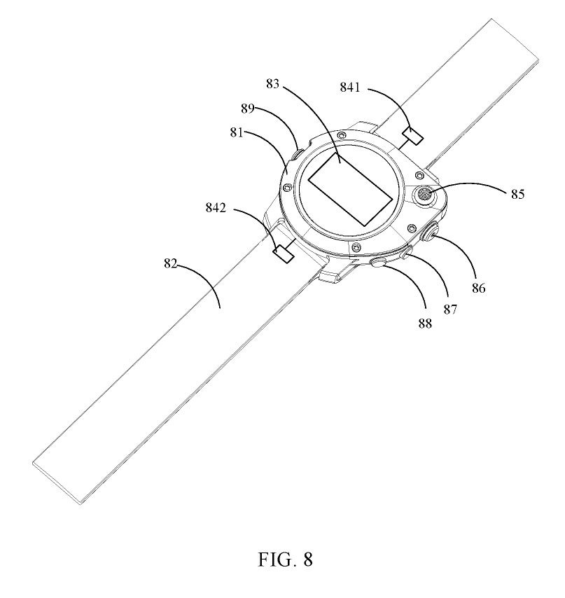

FIG. 8 illustrates a schematic external-view of an exemplary wearable device consistent with disclosed embodiments. In some embodiments, the wearable device may be a watch or a wristband and includes a housing body 81 and a wrist band 82. In some other embodiments, the wearable device may be designed in other forms, such as a necklace, glasses, earphones, clothes, etc. In this embodiment, the processor 101, the communication circuit 102 and various sensors described above may be arranged inside the housing body 81 and covered by a display screen 83. Moreover, the housing body 81 includes physical buttons 85 through 89 for implementing the functions of the various buttons described above. For example, the button 85 may be a five-dimensional button, which may implement at least part of the control functions corresponding to the direction button 108, or corresponding to both of the direction button 108 and the multiplex button 109. For example, when the physical button 85 is in one of the pressed state or the unpressed state, the flight control instruction may be generated by operation of other dimensions of the physical button 85 to control flight directions of the UAV 20 (e.g., front, back, left, or right). When the physical button 85 is in the other one of the pressed state or the unpressed state, the shooting control instruction may be generated by operation of other dimensions of the physical button 85 to control the shooting directions of the imaging device 23.

Furthermore, the operator may select operating parameters and confirm the operation via the button 86 when the display screen 83 displays the parameters of the UAV or a camera. The button 86 may also control the capturing of the imaging device 23. The button 87 may control the ascending of the UAV 20, the button 88 may control the descending of the UAV 20, and the button 89 may control to switch on the wearable device 10.

It can be understood that when the UAV is not controlled by the wearable device, the display screen 83 may display a current time, and thus the wearable device can serve as a watch.

Further, the communication circuit 102, some of the sensors (e.g., the position sensor 201), or antennas 841 and 842 may be arranged the wrist band 82, thereby simplifying circuit layout within the housing body 81. In some other embodiments, the antennas 841 and 842 may also be arranged inside the housing body 81, or at other suitable positions of the wearable device, which is not limited herein.

In summary, those skilled in the art can easily understand that, in the wearable device for controlling the UAV and the UAV system consistent with the present disclosure, the ground-control terminal of the UAV may be set as the form of the wearable device, which can effectively enhance the portability of the ground-control terminal. Further, the corresponding control instructions may be generated according to the detected status information of the wearable device, thus effectively lowering the operation complexity.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present invention is not intended to be limited to the embodiments shown herein but is to be accorded the widest scope consistent with the principles and novel features disclosed herein.

What is claimed is:

1. A wearable device for controlling an unmanned aerial vehicle (UAV) comprising:
one or more sensors configured to detect first status information of the wearable device;
a communication circuit configured to transmit the first status information to the UAV and receive second status information of the UAV from the UAV; and
a processor configured to:
generate a control instruction according to at least one of the first status information or the second status information; and
control the communication circuit to transmit the control instruction to the UAV to control the UAV.

2. The wearable device according to claim 1, wherein:
the one or more sensors comprise a position sensor configured to detect position information of the wearable device; and
the first status information comprises the position information.

3. The wearable device according to claim 2, wherein:
the position information of the wearable device is first position information;
the second status information comprises second position information of the UAV; and
the processor is further configured to generate a flight control instruction according to the first position information and the second position information, the flight control instruction controlling the UAV to adjust a projection distance of the UAV and the wearable device on a horizontal plane.

4. The wearable device according to claim 2, wherein:
the position information of the wearable device is first position information;
the second status information comprises second position information and orientation information of the UAV; and
the processor is further configured to generate a flight control instruction or a shooting control instruction according to the first position information, the second position information, and the orientation information, the flight control instruction controlling the UAV to adjust a preset reference direction of the UAV on a horizontal plane, and the shooting control instruction controlling the UAV to adjust a shooting direction of an imaging device carried by the UAV on the horizontal plane.

5. The wearable device according to claim 2, wherein:
the one or more sensors further comprise an altitude sensor configured to detect altitude information of the wearable device; and
the first status information further comprises the altitude information.

6. The wearable device according to claim 5, wherein:
the altitude information of the wearable device is first altitude information;
the second status information comprises second altitude information of the UAV; and
the processor is further configured to generate a flight control instruction according to the first altitude information and the second altitude information, the flight control instruction controlling the UAV to adjust a relative altitude between the UAV and the wearable device.

7. The wearable device according to claim 5, wherein:
the position information of the wearable device is first position information and the altitude information of the wearable device is first altitude information;
the second status information comprises second position information and second altitude information of the UAV; and
the processor is further configured to generate a flight control instruction or a shooting control instruction according to the first position information, the first altitude information, the second position information, and the second altitude information, the flight control instruction controlling the UAV to adjust a preset reference direction of the UAV on a vertical plane, and the shooting control instruction controlling the UAV to adjust a shooting direction of an imaging device carried by the UAV on the vertical plane.

8. The wearable device according to claim 2, wherein:
the one or more sensors further comprise an orientation sensor configured to detect orientation information of the wearable device;
the first status information further comprises the orientation information;
the position information of the wearable device is first position information;
the second status information comprises second position information of the UAV; and
the processor is further configured to generate a flight control instruction according to the first position information, the orientation information, and the second position information, the flight control instruction controlling the UAV to adjust a relative orientation of the UAV with respect to the wearable device.

9. The wearable device according to claim 2, wherein:
the position information of the wearable device is first position information;
the second status information includes second position information of the UAV; and
the processor is further configured to:
record the first position information or the second position information;
generating a motion path of the wearable device or the UAV; and
associate pictures or videos captured by the UAV with the motion path.

10. The wearable device according to claim 9, wherein the processor is further configured to:
match the second position information of the UAV at which the pictures or the videos are captured with the first position information or the second position information on the motion path; and
associate the pictures or the videos with position points on the motion path that match the second position information of the UAV at which the pictures or the videos are captured.

11. The wearable device according to claim 1, wherein:
the at least one sensor comprises a motion sensor configured to detect a motion parameter of the wearable device;
the first status information comprises the motion parameters; and
the processor is further configured to generate the control instruction according to the motion parameter.

12. The wearable device according to claim 11, further comprising:
a memory storing at least one action template and at least one candidate control instruction associated with the at least one action template;
wherein the processor is further configured to:
match an action instruction formed according to the motion parameter with one of the at least one action template; and
determine one of the at least one candidate control instruction that is associated with the one of the at least one action template as the control instruction.

13. The wearable device according to claim 12, wherein:
the motion sensor comprises an inertial sensor; and
the action instruction is formed by integrating values of the motion parameter outputted by the inertial sensor over time.

14. The wearable device according to claim 11, wherein:
the processor is further configured to directly map the motion parameter into a flight control instruction or a shooting control instruction; and
the flight control instruction controls a flight status of the UAV, and the shooting control instruction controls a shooting status of an imaging device carried by the UAV.

15. The wearable device according to claim 11, wherein:
the processor is further configured to:
generate a call control instruction according to the motion parameter; and
generate a flight control instruction or a shooting control instruction in response to the call control instruction; and
the flight control instruction controls a flight status of the UAV, and the shooting control instruction controls a shooting status of an imaging device carried by the UAV.

16. The wearable device according to claim 15, wherein the flight control instruction controls the UAV to adjust a relative position of the UAV with respect to the wearable device, or the shooting control instruction controls the imaging device to adjust a shooting direction.

17. The wearable device according to claim 16, wherein the processor is further configured to visually recognize an operator from pictures or videos captured by the imaging device.

18. The wearable device according to claim 1, further comprising:
one or more buttons;
wherein the processor is further configured to generate the control instruction according to an operation on the one or more buttons.

19. The wearable device according to claim 18, wherein:
the one or more buttons comprise a direction button configured to instruct the processor to generate a flight control instruction or a shooting control instruction;
the flight control instruction controls a flight status of the UAV; and
the shooting control instruction controls a shooting status of an imaging device carried by the UAV.

20. The wearable device according to claim 19, wherein:
the one or more buttons further comprise a multiplex button; and
the direction button is configured to instruct the processor to:
generate the flight control instruction in response to the multiplex button being in a first state; and
generate the shooting control instruction in response to the multiplex button being in a second state.

21. The wearable device according to claim 18, wherein the one or more buttons further comprise at least one:
a take-off button configured to control the UAV to take off;
a landing button configured to control the UAV to land;
a return button configured to control the UAV to return to a preset position; or
a follow button configured to control the UAV to follow a preset target.

22. The wearable device according to claim 1,
wherein the wearable device is a watch or a wristband comprising a housing body and a band, the communication circuit or at least a portion of an antenna of the one or more sensors being arranged at the band.

23. The wearable device according to claim 1, further comprising:
a display screen configured to display the first status information and at least one of the second status information, pictures, or videos received via the communication circuit.

24. The wearable device according to claim 23,
wherein the display screen comprises:
a semi-transparent-semi-reflective liquid crystal display (LCD) panel; and
a backlight module;
the wearable device further comprising:
a backlight control button or an ambient-light sensor; and
wherein the backlight module is configured to selectively provide backlight for the semi-transparent-semi-reflective LCD panel according to a backlight control instruction generated by the backlight control button or an ambient-light intensity detected by the ambient-light sensor.

25. The wearable device according to claim 1, wherein the communication circuit comprises:
an Industrial Scientific Medical band (ISM) communication circuit configured to communicate with the UAV; and
a WIFI communication circuit configured to communicate with a server terminal to download data from or upload data to the server terminal.
